(19) United States
(12) Patent Application Publication
(10) Pub. No.: US 2015/0097553 A1
(43) Pub. Date: Apr. 9, 2015

(54) DEVICE AND METHOD FOR MEASURING VERY LOW FREQUENCY ELECTROMAGNETIC FIELDS

(71) Applicant: The Mind App Ltd Oy, Grankulla (FI)

(72) Inventor: Gustaf Walter Kranck, Grankulla (FI)

(73) Assignee: The Mind App Ltd Oy, Grankulla (FI)

(21) Appl. No.: 14/280,091

(22) Filed: May 16, 2014

Related U.S. Application Data
(60) Provisional application No. 61/887,252, filed on Oct. 4, 2013.

(51) Int. Cl. G01N 27/74; G06F 17/18

(52) U.S. Cl. CPC G01N 27/74; G06F 17/18
USPC 324/204

(57) ABSTRACT

A measuring device for measuring one or more electromagnetic fields is provided. The measuring device includes a measuring sensor arrangement which is operable to detect the one or more electromagnetic fields and to generate one or more corresponding measurement signals; moreover, the measuring device further includes a data processing arrangement which is operable to process the one or more corresponding signals to generate an analysis of the one or more electromagnetic fields. Furthermore, the measuring device includes a liquid for at least partially influencing at least a part of the measuring sensor arrangement for simulating one or more physiological effects of the one or more electromagnetic fields.

### TECHNICAL FIELD

The present disclosure relates to devices for measuring electromagnetic fields, for example for measuring magnetic fields having frequency components of less than 256 Hz, for example for measuring such electromagnetic fields via use of water-based physiological solutions. Moreover, the present disclosure concerns methods of aforesaid measuring electromagnetic fields. Furthermore, the present disclosure relates to software products recorded on non-transient machine-readable data storage media, wherein the computing product are executable upon computing hardware of aforesaid devices for implementing aforesaid methods.

### BACKGROUND

As most electromagnetic fields encountered in everyday situations are those generated by household or industrial appliances, a majority of electromagnetic field (EMF) meters that are commercially available are calibrated to measure alternating electromagnetic fields have a frequency in a range of 50 and 60 Hz alternating fields, namely nominal alternating frequencies associated with US and European electricity distribution networks. There are other meters which can measure alternating electromagnetic fields at frequencies as low as 20 Hz, but meters tend to be much more expensive and are usually only used for specific research purposes. For example, a meter which is operable to measure low-frequency alternating magnetic fields is exemplified by a Primitive open source Arduino EMF Meter™: details of this meter are to be found at an Internet website: www.youtube.com/watch?v=y1Bke3750WE. Moreover, an example of a conventional well-known EMF meter is to be found at an Internet website: http://www.emfields.org/detectors/elf.asp. Moreover, a patent application describing an apparatus for monitoring health, wellness and fitness is to found at: US 2006/0122474 A1 (Bodymedia Inc., published 8 Jun. 2006). Moreover, most common measuring apparatus measure only the strength of the electric and/or magnetic field from a very large range of frequencies (for instance Gigahertz Solutions which meters show only the total field strengths for all frequencies between 5 Hz to 100000 Hz, http://www.gigahertz-solutions.de/media/downloads/manuals/130-551_ME3030-3830-3840rev19_INT.pdf)

Known traditional consumer electromagnetic field (EMF) measuring devices use standard technical methods to measure magnetic- and/or electrical-fields in an environment. These devices do not generally analyse more narrow bandwidths, and they also do not provide details of specific frequencies or real-time interfaces in order for a given user to investigate specific details of received EMF's. Moreover, known traditional EMF measuring devices have not been very effective for use when determining why some people feel and consider EMF pollution harmful to their health. A considerable proportion of the human population is ready to adjust its living- and working-surroundings to ‘“as free as possible” from EMF pollution, until it is possible to understand better a nature and location of EMF's.

It has been known for many years that short-wavelength high-energy radiation, for example X-rays and Gamma rays, is harmful to humans, because quanta associated such radiation have sufficient energy to break chemical bonds in human tissue, for example in DNA molecules which convey genetic information; in consequence, genetic mutations potentially arise resulting in a development of one or more tumours or cancer. Moreover, there has been a misunderstanding that low frequency electromagnetic radiation has sufficiently low quanta that are enable to break chemical bonds, and are hence generally harmless, apart from their thermal heating effects on biological tissue; such assumption pertains to microwave ovens and mobile telephones which function to emit electromagnetic radiation at substantially microwave frequencies. However, it is well known that unusual effects arise when, for example, water is subject to radiation of such microwave frequencies. For example, it is well known that water heated in a microwave oven is susceptible to becoming superheated, and that molecular resonances associated with such superheating take up to several minutes to decay upon cessation of such microwave-induced heating. “Microwave radiation” is herewith considered to comprise electromagnetic radiation in a frequency range of circa 800 MHz to 50 GHz.

Biological molecules have long-chain molecules which are susceptible to resonating when subjected to electromagnetic radiation at microwave frequencies and below. Interactions between molecules occur within biological systems on account spatially-varying electrostatic potentials along such molecules. However, when such molecules are caused to resonate by being exposed to pulsed radiation, for example pulsed microwave radiation emitted by a mobile telephone, their surface potentials at an atomic scale become blurred. This result, for example, when a human brain is exposed to microwave radiation emitted from a mobile telephone being held in close spatial proximity thereto, molecules in the brain are excited into resonance, and their surface electrostatic characteristics become blurred, triggering a range of spurious chemical reactions in the brain which would not occur in an absence of such radiation exposure. These spurious reactions then trigger an immune response in the brain which, if excessive, results in nerve damage and/or tumour growth. Such an effect occurs, even if the radiation exposure is below a threshold where thermal effects could be detrimental. It is for this reason that the World Health Organisation (WHO) classifies mobile telephone radiation as a “class-B” carcinogen (World Health Organisation, International Agency for Research on Cancer, Press Release no. 208, 31 May 2011). Headaches and tinnitus induced by exposure to such radiation emitted from mobile telephones are relatively common, especially when sustained over a long period, for example minutes, during which an immune response is invoked.

It will be appreciated from the foregoing that a conventional view that microwave radiation has insufficient quantum energy to split chemical bonds, other than by thermal heating effects, is a gross over simplification of a manner in which electromagnetic radiation influences complex biological systems, for example the human brain. It has also been appreciated that extremely low frequency radiation, for example at frequencies of 60 Hz and less, is also capable of causing damage in biological systems, even despite quanta associated with such low-frequency radiation being well below a range in which they are able directly to cause breakage of chemical bonds in molecules.

Devices such as mobile telephones, wireless LANs, wireless WANs and similar are operable to send data at substantially microwave frequencies. However, in digital communication systems employing such devices, data is sent in packets or bursts of data flow, which result both in radiation being emitted at microwave frequencies, but sub-harmonic Fourier components of such radiation which extend to low frequencies. Hitherto, there has been a lack of devices for measuring effects of such radiation, and hence it has been difficult for people to assess potential risks of exposure to such radiation.

Hence, there exists a need for a device which is operable to measure invisible electromagnetic pollution (EMP) in one or more given environments, and to indicate how much such pollution occurs and how the pollution has an effect on human lives.

Measurement of electromagnetic field is described in earlier literature, and reference is made to documents in Table 1 as a general background indicating known technical art.

TABLE 1
Known technical art

| Ref | Details |
|---|---|
| US2012/0226135A1 | “Primary source mirror for biomagnetometry” |
| | (Moment Technologies Inc.) |
| WO2009/138934A1 | “Method and system for detecting a fluid |
| | distribution in an object of interest” |
| | (Philips Electronics) |
| US2012/0220883A1 | “Physiological sensor delivery device |
| | and method” (Acist Medical Systems) |
| US2010/0049078A1 | “Method and apparatus for disease diagnosis |
| | and screening using extremely low |
| | frequency electromagnetic fields” |
| WO2013079704A1 | “Measuring chamber and an optical sensor |
| | for determining a concentration of a substance |
| | in the tissue fluid of a mammal” (Schildtec) |
| US74113918B2 | “Magnetic-field-measuring probe” (Centre |
| | National d'Etudes Spatiales) |

### SUMMARY

The present disclosure seeks to provide an improved device which is operable to measure physiological effects of electromagnetic radiation, for example low-frequency electromagnetic radiation.

Moreover, the present disclosure seeks to provide an improved method of measuring physiological effects of electromagnetic radiation, for example low-frequency electromagnetic radiation.

Furthermore, the present disclosure provides a device and method for measuring very low frequency electromagnetic fields in the surroundings with the help of water based liquid.

Furthermore, the present disclosure seeks to provide a device and a method for measuring extremely low frequency electromagnetic field, for example at frequencies of substantially 60 Hz and lower.

Furthermore, the present disclosure seeks to provide a device and a method which not only measures the strengths of the electric field component in EMF but also provides real time detailed information about the strength of each individual very low frequency field between 0-256 Hz.

According to a first aspect, there is provided a measuring device as defined in appended claim 1: there is provided a measuring device for measuring one or more electric field component of the electromagnetic fields, wherein the measuring device includes:

(i) a measuring sensor arrangement which is operable to detect the one or more electromagnetic fields and to generate one or more corresponding measurement signals; and
(ii) a data processing arrangement which is operable to process the one or more corresponding signals to generate an analysis of the one or more electromagnetic fields,
wherein the measuring device includes a liquid for at least partially influencing at least a part of the measuring sensor arrangement for simulating one or more physiological effects of the one or more electromagnetic fields.

The invention is of advantage in that the measuring device is capable of providing a more representative measurement of the electric field component in the electromagnetic field in relation to its physiological effects.

Optionally, the measuring device is operable to measure one or more components of the one or more electromagnetic fields at very low frequencies, wherein the very low frequencies are less than substantially 256 Hz.

Optionally, the measuring device is operable to measure and analyze the one or more electromagnetic fields in one or more frequency ranges, namely:
(i) in a Delta frequency range of substantially 1 Hz to 4 Hz;
(ii) in a Theta frequency range of substantially 4 Hz to 7 Hz;
(iii) in frequency ranges centred on one of more of frequencies 50 Hz, 60 Hz, 100 Hz, 120 Hz, 150 Hz, 180 Hz, 200 Hz, 240 Hz, wherein the frequency range are substantially −1 Hz to +2 Hz of their respective centre frequency;
(iv) in a Gamma frequency range of substantially 40 Hz to 98 Hz.
   The Delta frequency range is mostly associated with sleep when undertaking EEG analysis. Moreover, the Theta frequency range is associated with drowsiness and, for instance, meditation. For utility Pollution (UP), mainly for estimating an effect of 50/60 Hz AC, there is beneficially employed combined utility pollution bands, centered on 50 Hz, 60 Hz, 100 Hz, 120 Hz, 150 Hz, 180 Hz, 200 Hz, 240 Hz, with an associated centering function: −1 Hz to +2 Hz. Furthermore, the Gamma frequency range is considered to be important to follow when the human brain processes memories; for the measuring device, this range is important because of its relevance to interference between human body-related frequencies and general EMF polluting frequencies such as utility pollution and wireless communication signals.

Optionally, the measuring device further includes a display arrangement for presenting in operation the analysis of the one or more electromagnetic fields.

Optionally, in the measuring device, the measuring sensor arrangement includes a plurality of sensors, of which at least one sensor is operable to sense an ambient electromagnetic field external to the measuring device, and at least one sensor which is operable to sense an electromagnetic field which penetrates into the liquid.

More optionally, in the measuring device, at least one sensor which is operable to sense an ambient electromagnetic field external to the measuring device is disposed at a periphery of the measuring device in a manner at least partially surrounding the liquid.

More optionally, in the measuring device, a region in which one or more electromagnetic fields are measured is disposed within a metal pipe or a region which is at least partially surrounded by ceramics materials.

More optionally, in the measuring device, the at least one sensor which is operable to sense an electromagnetic field which penetrates into the liquid is disposed within the liquid, wherein the liquid comprises at least one of:
(i) a water-based solution comprising one or more salts;
(ii) a water-based suspension of biological material;
(iii) a water-based mixture of biological long-chain molecules which have one or more molecular resonances corresponding to the electromagnetic field; and
(iv) a water-based mixture containing magnetotactic bacteria.

More optionally, in the measuring device, the water-based solution comprises substantially in a range of substantially 0.1% to 2.0% salt solution. Yet more optionally, in the measuring device, the water-based solution comprises substantially 0.9% (+/−0.2%) Sodium Chloride (NaCl).

Optionally, in the measuring device, at least one sensor which is operable to sense an ambient electromagnetic field external to the measuring device is disposed with an air gap between it and a region comprising the liquid, wherein the air gap is in a range of 2 mm to 10 mm, more optionally substantially 5 mm.

Optionally, in the measuring device, the data processing arrangement is operable to present the analysis in a form of frequency spectrum results.

Optionally, in the measuring device, the data processing arrangement is operable to compute, for the analysis, a weighed average index (I) of a plurality of average levels (A), a standard deviation of the average of a plurality of average levels (B), and a correlation of the average levels (C).

Optionally, in the measuring device, the data processing arrangement is operable to compute the average levels (A) based upon the average of measured frequency band magnitude values.

Optionally, in the measuring device, the data processing arrangement is operable to compute a standard deviation of the average of the plurality of average levels (B) based upon an average of the standard deviation according to a weighing factor (wf).

Optionally, in the measuring device, the data processing arrangement is operable to compute a correlation of the average levels (C) based upon a relative change in average level frequency band magnitudes compared to change in measured specific frequency band magnitudes.

Optionally, in the measuring device, the data processing arrangement is operable to compute the analysis by employing computing resources based in a computing hub which is spatially remote from the measuring sensor arrangement.

According to a second aspect, there is provided a method of using a measuring device for measuring one or more electromagnetic fields, wherein the method includes:
(a) using a measuring sensor arrangement to detect the one or more electromagnetic fields and to generate one or more corresponding measurement signals; and
(b) using a data processing arrangement to process the one or more corresponding signals to generate an analysis of the one or more electromagnetic fields,
   wherein the method includes, for the measuring device, using a liquid for at least partially influencing at least a part of the measuring sensor arrangement for simulating one or more physiological effects of the one or more electromagnetic fields.

Optionally, when implementing the method, the measuring device is operable to measure one or more components of the one or more electromagnetic fields at very low frequencies, wherein the very low frequencies are less than substantially 256 Hz.

Optionally, when implementing the method, the measuring device is operable to measure and analyze the one or more electromagnetic fields in one or more frequency ranges, namely:
(i) in a Delta frequency range of substantially 1 Hz to 4 Hz;
(ii) in a Theta frequency range of substantially 4 Hz to 7 Hz;
(iii) in frequency ranges centred on one of more of frequencies 50 Hz, 60 Hz, 100 Hz, 120 Hz, 150 Hz, 180 Hz, 200 Hz, 240 Hz, wherein the frequency range are substantially −1 Hz to +2 Hz of their respective centre frequency;
(iv) in a Gamma frequency range of substantially 40 Hz to 98 Hz.
   The Delta frequency range is mostly associated with sleep when undertaking EEG analysis. Moreover, the Theta frequency range is associated with drowsiness and, for instance, meditation, For Utility Pollution (UP), mainly for estimating an effect of 50/60 Hz AC, there is beneficially employed combined utility pollution bands, centered on 50 Hz, 60 Hz, 100 Hz, 120 Hz, 150 Hz, 180 Hz, 200 Hz, 240 Hz, with an associated centering function: −1 Hz to +2 Hz. Furthermore, the Gamma frequency range is considered to be important to follow when the human brain processes memories; for the measuring device, this range is important because of its relevance to interference between human body-related frequencies and general EMF polluting frequencies such as utility pollution and wireless communication signals.

Optionally, the method includes using a display arrangement of the measuring device for presenting in operation the analysis of the one or more electromagnetic fields.

Optionally, when implementing the method, the measuring sensor arrangement includes a plurality of sensors, of which at least one sensor is operable to sense an ambient electromagnetic field external to the measuring device, and at least one sensor which is operable to sense an electromagnetic field which penetrates into the liquid. More optionally, in the method, the at least one sensor which is operable to sense an ambient electromagnetic field external to the measuring device is disposed at a periphery of the measuring device in a manner at least partially surrounding the liquid.

Optionally, when implementing the method, the at least one sensor which is operable to sense an electromagnetic field which penetrates into the liquid is disposed within the liquid, wherein method includes arranging for the liquid comprises at least one of:
(i) a water-based solution comprising one or more salts;
(ii) a water-based suspension of biological material;
(iii) a water-based mixture of biological long-chain molecules which have one or more molecular resonances corresponding to the electromagnetic field; and
(iv) a water-based mixture containing magnetotactic bacteria.

Optionally, when implementing the method, the water-based solution comprises substantially in a range of substantially 0.5% to 2.0% salt solution. More optionally, when implementing the method, the water-based solution comprises substantially 0.9% Sodium Chloride (NaCl).

Optionally, when implementing the method, the at least one sensor which is operable to sense an ambient electromagnetic field external to the measuring device is disposed with an air gap between it and a region comprising the liquid, wherein the air gap is in a range of 2 mm to 10 mm, more optionally substantially 5 mm.

Optionally, when implementing the method, the data processing arrangement is operable to present the analysis in a form of frequency spectrum results.

Optionally, when implementing the method, the data processing arrangement is operable to compute, for the analysis, a weighed average index (I) of a plurality of average levels (A), a standard deviation of the average of a plurality of average levels (B), and a correlation of the average levels (C).

Optionally, when implementing the method, the data processing arrangement is operable to compute the average levels (A) based upon the average of measured frequency band magnitude values.

Optionally, when implementing the method, the data processing arrangement is operable to compute a standard deviation of the average of the plurality of average levels (B) based upon an average of the standard deviation according to a weighing factor (wf).

Optionally, when implementing the method, the data processing arrangement is operable to compute a correlation of the average levels (C) based upon a relative change in average level frequency band magnitudes compared to change in measured specific frequency band magnitudes.

Optionally, when implementing the method, the data processing arrangement is operable to compute the analysis by employing computing resources based in a computing hub which is spatially remote from the measuring sensor arrangement.

According to a third aspect, there is provided a software product recorded on non-transient machine-readable data storage media, wherein the software product is executable upon computing hardware of the data processing arrangement of the measuring device pursuant to the first aspect for implementing a method pursuant to the second aspect.

It will be appreciated that features of the invention are susceptible to being combined in various combinations without departing from the scope of the invention as defined by the appended claims.

Additional aspects, advantages, features and objects of the present disclosure would be made apparent from the drawings and the detailed description of the illustrative embodiments. Moreover, it will be appreciated that features of the disclosure are susceptible to being combined in various combinations or further improvements without departing from the scope of the disclosure and this patent application.

### DESCRIPTION OF THE DIAGRAMS

The summary above, as well as following detailed descriptions of illustrative embodiments, is better understood when read in conjunction with herewith appended drawings. For the purpose of illustrating embodiments of the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

Embodiments of the present invention will now be described, by way of example only, with reference to the following diagrams wherein:

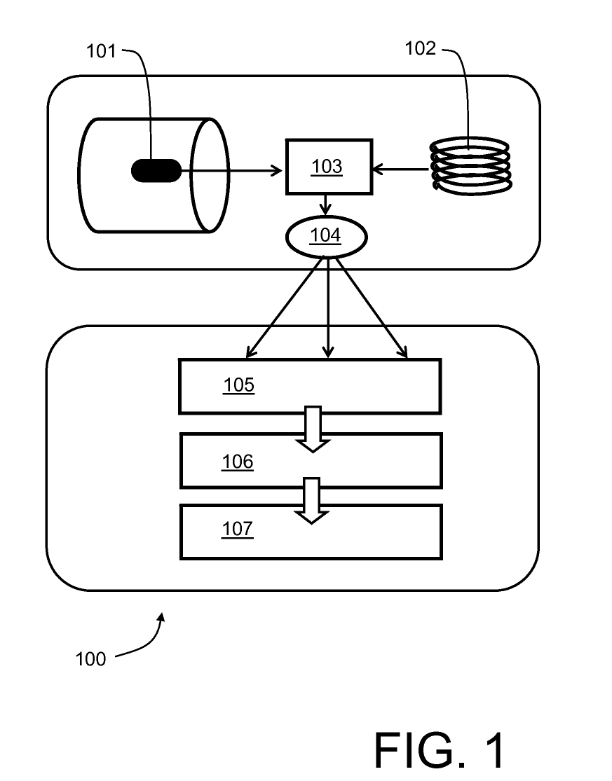

FIG. 1 is an illustration of a sensor arrangement employed in a measuring device pursuant to the present disclosure for measuring electromagnetic radiation, for example extremely low frequency electromagnetic radiation, for example at radiation frequencies of substantially 100 Hz and lower;

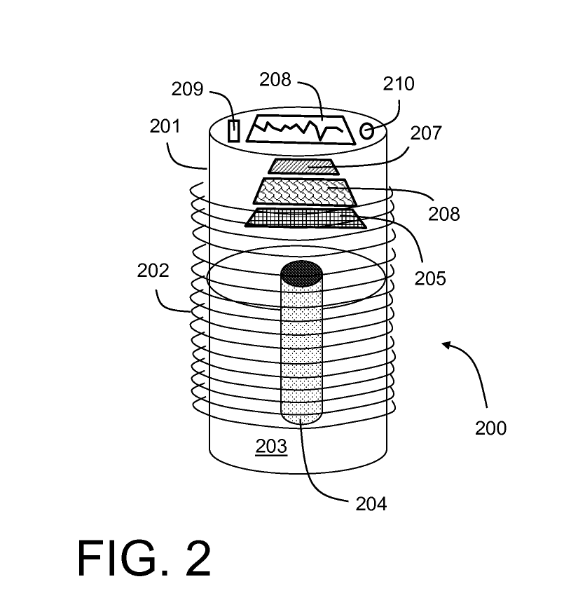

FIG. 2 is an illustration of steps of a method of computing an index indicative of EMP as measured by the measuring device of FIG. 1;

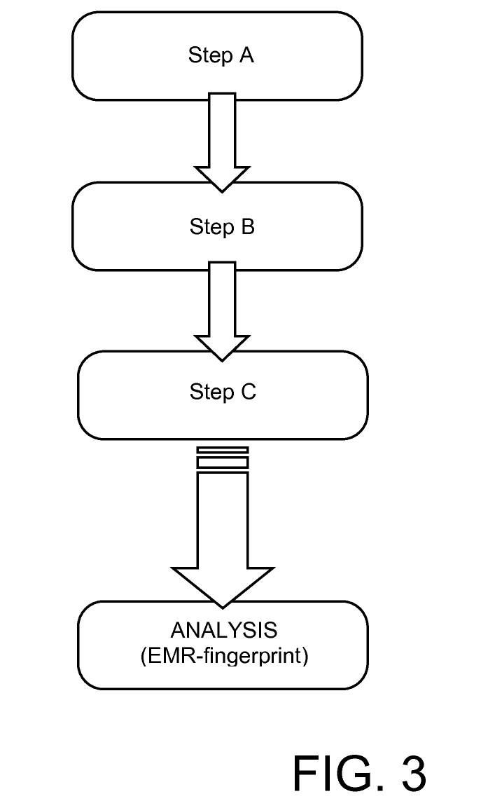

FIG. 3 is an illustration of a configuration of a measuring device for measuring extremely low frequency (ELF) magnetic field pollution, for example in a living and working environment;

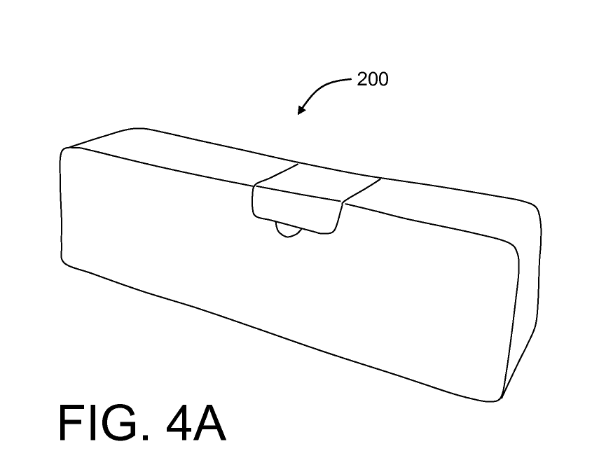

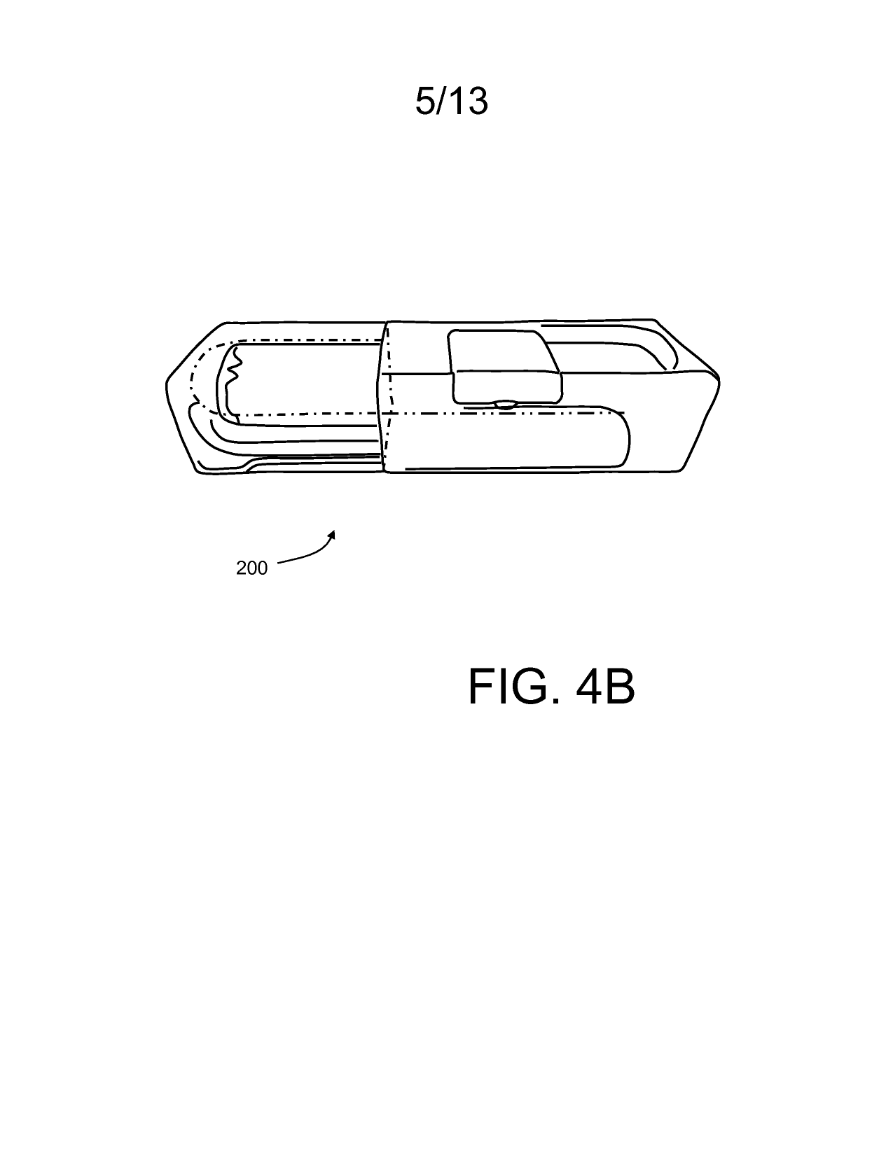

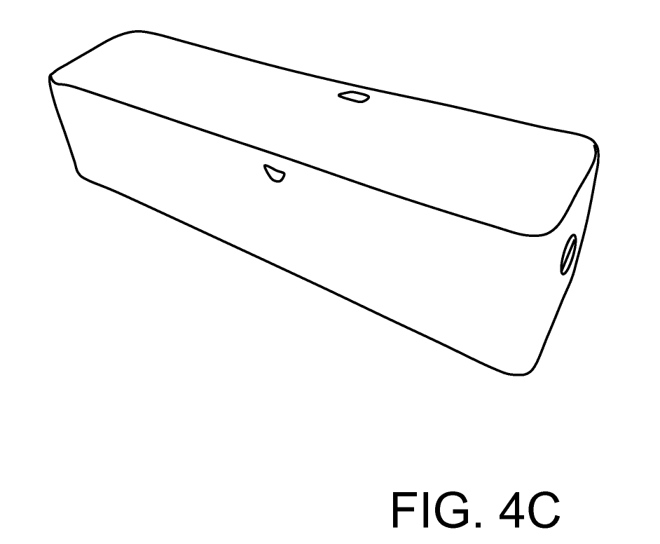

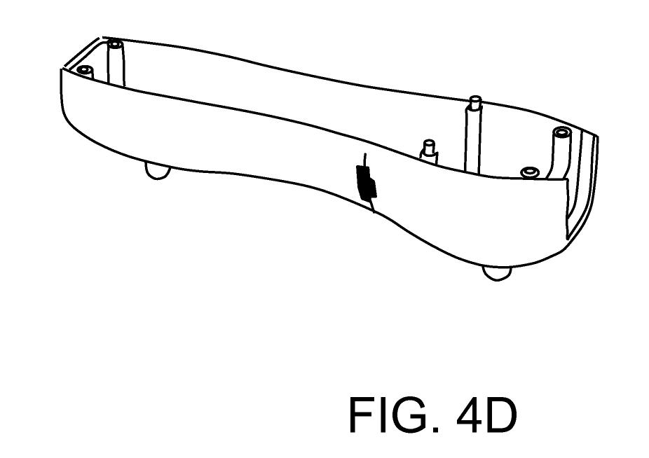

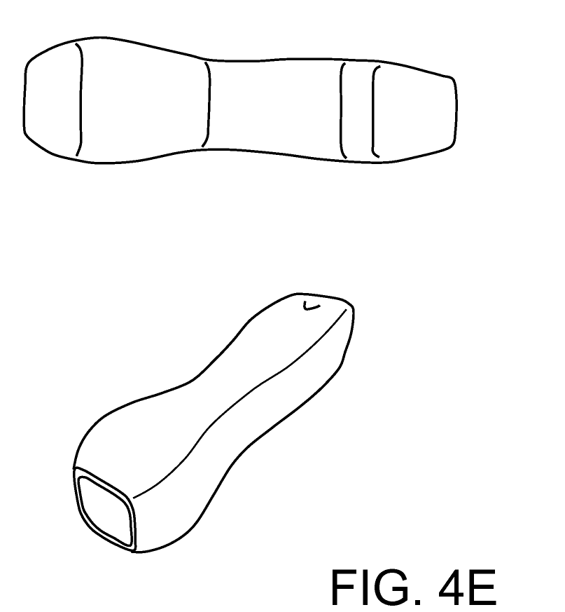

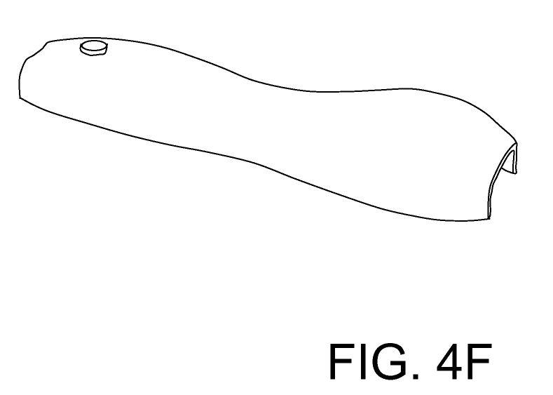

FIG. 4A, FIG. 4B and FIG. 4C are illustrations of external views of external parts of a first device pursuant to the present disclosure;

FIG. 4D, FIG. 4E and FIG. 4F are illustrations of external views of external parts of a second device pursuant to the present disclosure;

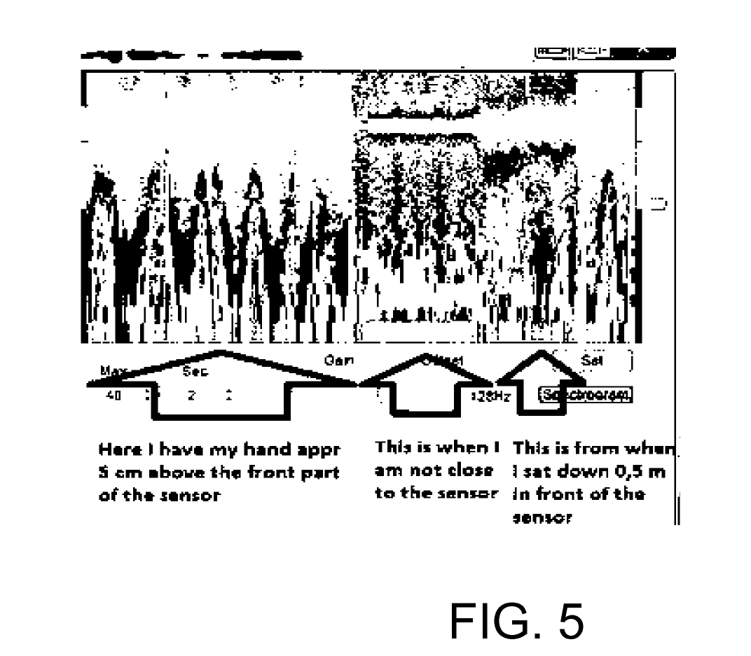

FIG. 5 is an example illustration of a measured EMF fingerprint, namely EMF specifics, generated by using the measuring device of FIG. 1;

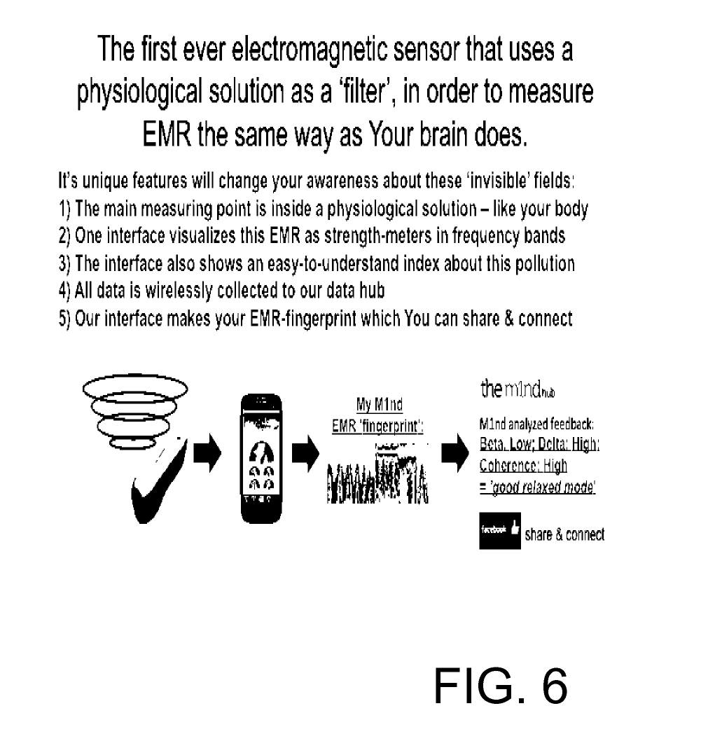

FIG. 6 is an overview of a social media EMF fingerprint sharing arrangement for the measuring device of FIG. 1;

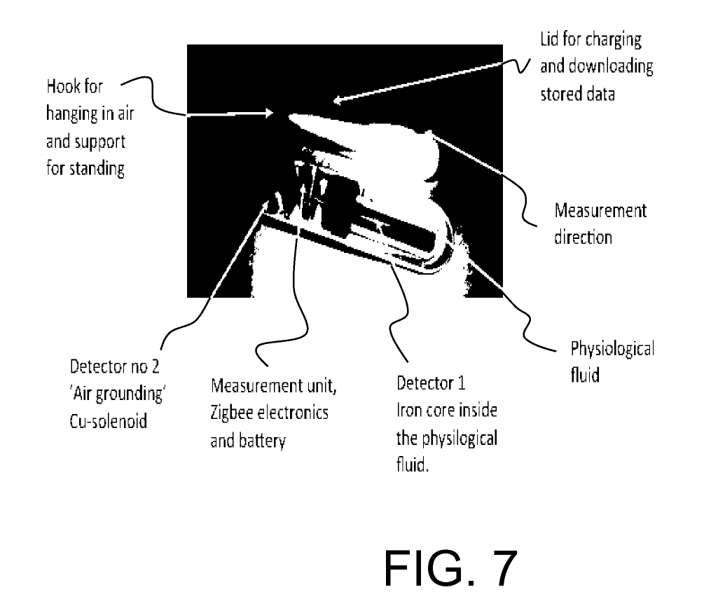

FIG. 7 is an external view of a practical implementation of the measuring device of FIG. 1; and

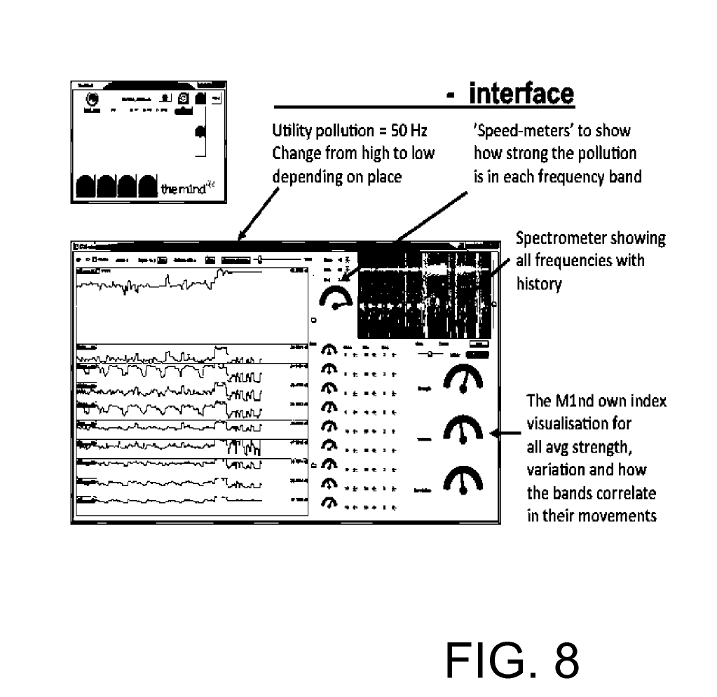

FIG. 8 is an example graphical interface of the EMF fingerprint sharing arrangement of FIG. 6.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EXEMPLARY EMBODIMENTS

Conventional known devices for measuring electromagnetic radiation seek to measure such radiation directly, namely in a manner which is as least influenced by other components. In contradistinction, embodiments of the present disclosure seek to measure electromagnetic radiation through a filter of a water-base solution which is designed to function in a manner of a physiological solution, namely directly simulating an environment in, for example, a human brain. Such a manner of measurement avoids incorrect assumptions in known technical art regarding a manner of interaction of such radiation with biological systems. As a result, embodiments of the present disclosure enable electromagnetic radiation to be measured in a manner which is more representative of effects of aforesaid electromagnetic pollution (EMP).

Referring next to FIG. 1, there is shown a schematic illustration of a measuring device indicated generally by 100. The measuring device 100 includes two sensors 101, 102, wherein the sensor 101 is at least partially surrounded by a water-based solution, where as the sensor 102 is spatially remote from the solution, for example in free air; the waster-based solution is arranged to be a physiological solution, for example implemented by using water and optionally at least one of: a salt, a suspension of biological cells, a suspension of polarised molecules, a suspension of electromagnetically polarized cells, but not limited thereto. Beneficially, the measuring device 100 is implemented so that the solution can be varied when performing an electromagnetic field measurement. The solution is intended to mimic characteristics of the human brain, for example molecular resonances.

The sensor 101 is optionally implemented so that its main detection region is a bar, a substantially single point or a rod. Moreover, the sensor 102 provides an electromagnetic “reference” or “ground” and is optionally implemented in a form of a solenoid or a substantially single-point magnetically sensitive region. The measuring apparatus 100 beneficially also includes a source of power, for example a rechargeable battery and/or disposable battery.

The measuring device 100 further includes sensitive electronic circuits which are employed with the measuring device 100 to amplify and then to provide an analysis of signals generated by the sensors 101, 102 when the measuring device 100 is employed in operation. For example, identical or substantially similar electronic circuits are employed to measure EEG (electroencephalogram) 103. Signals generated by the sensors 101, 102 are processed and then corresponding data is optionally sent in operation via a communication device 104 to a cloud computing environment whereat the corresponding data is further processed and characterized; the cloud computing environment optionally includes a data communication device 105 for receiving data from the communication device 104, a data hub 106 for processing received data, one or more databases for storing the processed data, one or more software products for implementing one or more algorithms when processing the received data, as well as a user interface visualization for generating analysis results, for example communicated back to the measuring device 100 and/or made available on a mobile telephone and/or made available on a personal computer (PC), tablet computer phablet computer or similar. Such signal processing is optionally performed, at least in part, in the communication device 104, for example when the measuring device 100 has considerable in-built data processing capacity; such processing enables the measuring device 100 to operated autonomously, for example in remote rural locations where EMP measurements are to be made. Results of one or more calculations associated with the data processing, for example an index of electromagnetic field components, are returned from the cloud computing environment as aforementioned and/or generated by the communication device 104 as aforementioned as a result of computations performed therein for presentation to one or more users of the measuring device 100, for example using a user interface visualization, for example a graphical user interface (GUI).

The data communication device 105 is optionally implemented as a personal computer (PC) with associated radio receiver, namely wireless enabled, together with data processing electronic circuits, for example implemented using a wireless receiver, a mobile phone or a webpad. In operation, the data communication device 105 communicates with the data hub 106 for storing data, performing computations of data, and performing data indexation. Moreover, the communication device 105 is operable to send data to the data hub 106 using any mode of communication, such as internet, WAN (Wide area network), LAN (Local Area Network), Wifi (or WLAN, Wireless LAN), Bluetooth, and so forth. The data hub 106n communicates with a user interface 107 for communicating results of analysis performed on measurement data generated by the measuring device 100. Optionally, the measuring device 100 includes one or more additional components which are operable to perform one or more functions of the communication device 105 and the data hub 106, for example to communicate directly with the user interface 107; optionally, a given user of the measuring device 100 interfaces by employing an integral LED screen, LCD screen, or other type of screen.

Next, a method of analyzing measurement data acquired from the sensors 101, 102 will be described. Such analysis of the measurement data is optionally performed in the data hub 106 as aforementioned. Beneficially, the analysis results in generation of an index value, for example referred to as being a “M1ND Sensor Electromagnetic Index”; the index provides an aggregate indication of an amount of EMP measured in a given environment whereat the measuring device 100 is employed.

In FIG. 3, steps of the method of analysing the data acquired from the sensors 101, 102.

In a first step A, magnitudes M of signal components within a plurality of frequency bands included within a measuring frequency range are computed by the measuring device 100; such magnitudes are optionally expressed in a range of 0 to 100 units. For the frequency bands, there is computed an average amplitude of the frequency bands, wherein such computation is beneficially implemented pursuant to Equation 1 (Eq. 1):

Avg=^{F}(dB,base,max,time₁,wf) Eq, 1

wherein:
Avg=average amplitude;
dB=sensitivity range;
base=a base value;
max=a maximum value limit;
time₁=a time duration of measurement;
wf=weighting factor; and
F=average computation function.

In a second step B, a standard deviation or volatility of the magnitudes M are computed, for example in a range of 0 to 100. For each of the frequency bands, there is computed an average of a standard deviation according to weighting, according to Equation 2 (Eq. 2):

S=G(M,time₂,wf) Eq. 2

wherein:
S=standard deviation of magnitudes M;
time₂=time during which the standard deviation S is computed;
wf=weighting factor; and
G=standard deviation computation function.

In a third step C, there is performed a correlation of magnitudes M for signals from the two sensors 101, 102, wherein computed correlations are beneficially expressed in a range of “−100”, corresponding to a positive correlation, to “+100”, corresponding to a negative correlation. This enables, for example, an effect of the aforementioned physiological solution to be appreciated readily. In the step C, a computation employed for such correlation utilizes variables, wherein each frequency band amplitude M is computed relative to a change in the average Avg compared to a change in the frequency band; thus, correlations are computed between Avglevel1, Avglevel2, and so forth. Beneficially, correlation variables employed are Avg(Hz), Hz of frequency band and weighting factor (wf).

In a fourth step D, there is computed the m1nd EMP Index, from a weighted average of computations performed in the steps A, B and C. Beneficially, the method as embodied in the steps A to D is implemented, at least in part, by using a software application in a mobile communication device, for example in a mobile telephone, for example a contemporary smart phone having considerable computing power; the software application (APP) beneficially presents the main index, and also sub-indexes, for example Ex, Avg level, wherein a value of “70” indicates a high value, a standard deviation of “30” represents a low value, and a strong positive correlation is denoted by “−50”, from which the m1nd EMP Index is computed to have a value of “17”, for example; such a set of values correspond, for example, to an inside of a house in which there is to be found many electronic devices and electrical machines, but wherein the devices and the machines are “in harmony”. A minimum value for m1nd EMP Index is conveniently a value “0”.

The measuring apparatus 100 beneficially provides its measurement results, for example via the aforementioned GUI, via use of RSS data feeds or social media communication via, for example, TWITTER™, FACEBOOK™, SMS, MMS, email, feeds, blogs or blog portions, web excerpts and so forth, for example via any data communication device such as a laptop computer, a personal computer, a desktop computer, a smart phone, a web tablet, a wireless devices; such wireless devices include, although are not limited to, smart phones, Mobile Internet Devices (MID), wireless-enabled tablet computers, Ultra-Mobile Personal Computers (UMPC), phablets, tablet computers, Personal Digital Assistants (PDA), web pads, cellular phones, and iPhone® and so forth.

Referring next to FIG. 2, there is shown an illustration of a sensor arrangement for implementing the measuring apparatus 100, wherein the sensor arrangement is indicated generally by 200. The sensor arrangement 200 constitutes an apparatus for measuring extremely low frequency (ELF) magnetic field pollution in a living and working environment. The sensor arrangement 200 has at least two sensors for providing measurement data indicative of electromagnetic and human bio-signal field parameters. The sensor arrangement 200 is a measurement device that simulates, at least partially, a physiology of the human head, for example a human brain. The sensor arrangement 200 is accommodated within a housing 201. The housing 201 is beneficially fabricated from plastics material or other similar non-electrically-conducting polymer. Outside the housing 201, there is provided a first sensor 202, corresponding to the aforesaid sensor 102, which is beneficially implemented in a form of solenoid winding, namely using metal wire wrapped around the housing 201. Between the first sensor 202, illustrated in FIG. 2 as being a solenoid, and the housing 201, there is provided an air gap having a radial width in a range of 2 mm to 10 mm, and more preferably substantially 5 mm; such a gap avoids electrostatic coupling, namely capacitive coupling, that otherwise potentially causes measurement errors. The first sensor 202 is used to sense electromagnetic fields outside the sensor arrangement 200. The measured signal from the first sensor 202 is routed to measurement electronics 205 which include one or more sensitive amplifiers, analog-to-digital converters (ADC), and other digital logic components.

In the sensor arrangement 200, a second sensor 204 is used to measure electromagnetic fields inside the sensor arrangement 200, namely within a water-based physiological solution which substantially mimics characteristics of a human brain. Optionally, the second sensor 204 includes an inner metallic core, for measuring signals inside the sensor arrangement 200. The metallic core is surrounded with liquid 203, beneficially a water-based physiological solution which mimics characteristics of the human brain. Optionally, the liquid 203 is a saline including in a range of 0.5% to 2% salt solution, for example Sodium Chloride (NaCl) saline solution, Potassium Chloride (KCl) solution or similar, more optionally substantially 0.9% NaCl saline solution, namely to simulate electromagnetic field damping effect of the human brain, namely to make physiological solution. There is connection from the second sensor 204 to the measurement electronics 205. Alternatively, or additionally, the physiological solution includes a suspension of organic cells, for example including long-chain organic molecules, ferromagnetic organic cells for simulating blood, proteins, but not limited thereto. Optionally, the sensor arrangement 200 is implemented so that the physiological solution is susceptible to being changed during measurements, for example by employing exchangeable plastics-material-walled chambers for containing the physiological solution which, when installed in the measuring arrangement 200, surround the second sensor 204.

Measured data from the first and second sensors 202, 204 respectively are routed to a data processing board 206 for analysis, such as Fast Fourier Transformation (FFT) for converting signals to corresponding harmonic components in a frequency domain. Signals originating from the first sensor 202, for example implemented in a form of a solenoid, and the second sensor 204, for example implemented with an inner metallic core, are compared to analyse if there are such electromagnetic signals in the air which might have impact on the human brain. In overview, the first sensor 202 produces a same signal, or substantially similar signal, as EEG would generate when measured from a human brain. The second sensor 204, for example using the aforesaid inner metallic core, provides a measurement signal which is more akin to signals that would be experienced in the human brain. The sensor arrangement 200 is optionally connectable to other devices via one or more connectors 209, 210 and 207. The sensor arrangement 200 includes a display 208 for presenting measurement results locally at the sensor arrangement 200. Optionally, the sensor arrangement 200 has a diameter in a range of 2 cm to 10 cm, more optionally substantially 4 cm; moreover, the sensor arrangement 200 optionally has an elongate length, namely height stood upright, in a range to 10 cm to 30 cm, and more optionally substantially 20 cm.

Referring next to FIG. 4A, FIG. 4B and FIG. 4C, there is shown an example view of the measuring device 100 which is susceptible to being employed for measuring very low frequency electromagnetic fields in ambient surroundings, wherein a water-based liquid enables a more represented physiological effect of the electromagnetic fields to be assessed. The measuring device 100 is designed to be lightweight, portable, easy to operate, and aesthetically attractive.

Referring next to FIG. 4D, FIG. 4E and FIG. 4F, there is shown an example view of external casing external parts for use when manufacturing the measuring device 100 in large quantities. The external casing parts are beneficially ergonomically-formed to enable the measuring device 100 to be held comfortably by a human hand. Moreover, the external casing parts are beneficially injection-moulded plastics material components, for example fabricated from ABS plastics material, glass-filled plastics material, phenolic resin or similar.

It has been appreciated that ambient electromagnetic radiation is susceptible to cause nerve stimulation, and potentially results in insomnia, tinnitus, fatigue and headaches. In a non-limiting application of the measuring device 100, a person who is suffering from insomnia beneficially places “The M1ND EMF Sensor” on his/her pillow and measures EMF pollution, namely aforementioned EMP, where he/she sleeps. If the interface and index shows results that are indicative that there are high levels of EEG-equivalent Delta and Theta pollution, namely EMP, such results are to be interpreted that the pollution is high in a frequency range that the human brain utilizes when sleeping or relaxing. A given user of the measuring device 100 is thereby able to conclude that this EMF pollution can be one factor disturbing his/her sleep. To provide further improvement, the given user is able to reduce or unplug electric devices close to such a bed and change a spatial location of the bed to a place where there is less EMF pollution, namely less EMP.

In respect of the aforesaid liquid 203, it is desirable that the liquid 203 is implemented in a manner that it is capable of being rapidly changed for the measuring device 100, 200; for example, the liquid 203 is optionally provided in a form of multiple cartridges which are interchangeable on the measuring device 100, 200. It is desirable that the liquid 203 is chosen to be representative of characteristics of the human brain, so that a representative assessment of EMP is obtainable.

Optionally, the liquid 203 is a stabilized bacterial solution, for example using one or more strains of bacteria which are known to be responsive to EMP. Such strains optionally include magnetotactic bacteria, for example magnetospirillum magnetotacticum bacteria, namely in order to utilize their magnetite nano-crystals for organic signal enhancement in the liquid 203, namely water-based solution. These magnetotactic bacteria are presently being research intensively on account of their relevance to constructing nano-computers, because their magnetite nano-crystals are found to be the most perfect magnetic crystals presently existing on Earth. They consequently are scientifically proven to be best possible receptors of electromagnetic radiation. However, the liquid 203 is optionally implemented using other mediums, for example mediums which are compounds of natural bacteria in water, CSF (cerebrospinal fluid) derivative solutions, solutions with bacteria from the human stomach and physiological solutions derived from blood.

Beneficially, the measuring device 100 is implemented such that the sensors 101, 102 are provided as multiple easy-to-change solution/antenna meter cartridge options. Preliminary tests have shown that different solution and antenna combinations result in different types of feedback, and hence a range of physiological measurements. By using target-specific solutions/antennas, it is feasible to assess in an more representative manner potentially adverse effects of EMP, for example in public venues such as industry, public transport, aircraft, near electrical power distribution installation, near mobile telephone transmission masts and so forth.

The measuring device 100 is susceptible, via one or more communication networks, for example via the Internet and/or wireless mobile telephone communication networks, to being used to share its measurement results, for example measurement results of EMP, via one or more social media platforms, for example amongst sufferers of tinnitus induced by exposure to pulsed mobile telephone radiation, to child-care groups wherein carers are concerned about detrimental effects of children being exposed to EMP, and so forth. The measuring device 203 is thereby capable of being used for performing EMF fingerprinting, as will be elucidated in greater detail later.

Beneficially, in association with the measuring device 100, there is provided a software product, namely a “Mind App” software application, which enables users of the measuring device 100 to share, via a “theM1nd Share” site hosted at one or more severs, “pictures” of how their bodies are emitting electromagnetic fields at any specific moment, for example as a consequence of wearing a mobile telephone in a holster around a waist region of a given user. The “Mind App” software application implements a method, wherein a first measurement of a given user environment without the given user is performed, and thereafter one or more measurements are made with the given user in spatial near proximity to the measuring device 100, for a hand of the given user is brought close to the measuring device 100 as the given user is carrying a mobile telephone which periodically emits substantially microwave radiation. Optionally, a measurement is made in respect of the given user, when the given user is not carrying any radiation emissive device.

From these two measurement, “theM1nd Share” will establish a given person's EMF emitting ‘EMR-fingerprint’, which shows specifics of the given person's body's emitting an electromagnetic field. These specifics are derived from a spectrogram and analysis, for example as processed by colour analyzing software. Optionally, it is feasible to share this ‘fingerprint’ on “theM1nd Share” site, for instance Facebook™, YouTube™ or similar social media network. Optionally, the given user receives artificial intelligence analysis from a “The M1nd Hub, namely a data distribution hub, for example including a configuration of data servers, of his/her EMF with the help of “The M1nd App”. Such analysis, for example, is optionally in a form of: ‘ . . . person xx and person yy both were in similar EMF-state today—do you want to share your EM field picture with them and do you want to discuss what caused your body to emit such a field?’. It is envisaged that this social interaction and sharing facility will be a major contributor to “the M1nd sensor” and the “M1nd hub” associated with use of the measuring device 100. The existence of a given person's body's EMF field is a well-established scientific fact, and there are thousands of research papers supporting the fact that the human body absorbs and emits low frequency electromagnetic fields, irrespective of whether or not a given human body is carrying an electronic radiation-emitting device. An example of EMF specifics is provided in FIG. 5.

In FIG. 5, the EMF fingerprint is derived from a difference between a first area, namely a given user's hand above the measuring device 100, and a second area namely when the given users is not sitting close to the measuring device 100. In this example case, a resulting colour spectrum presented, for example in FIG. 5, potentially gives a full analyzed picture of the given user's (electromagnetic radiation) EMR-fingerprint for each frequency band in a measuring frequency range of 0.5 Hz to 128 Hz, or 0.5 Hz to 256 Hz. Depending on strengths in respect of interrelationships of the strengths, artificial intelligence software based at an aforementioned data hub is able to provide a “state-comment” about a nature of a given user's current electromagnetic radiation, and hence the state of the given user's body's physiology.

The measuring device 100 is beneficially operable to measure electromagnetic fields in one or more main frequency ranges as provided in Table 2; the measuring device 100 is operable to measure and subsequently analyze such fields.

TABLE 2
Measurement frequency bands of the measuring device 100

| Measuring frequency range | Utilization |
|---|---|
| Delta, 1 Hz to 4 Hz | Mostly associated with sleep when |
| | undertaking EEG analysis |
| Theta, 4 Hz to 7 Hz | Associated with drowsiness and, for |
| | instance, meditation |
| combined utility pollution | Utility Pollution (UP), mainly to estimate |
| bands, centered on 50, 60, | an effect of 50/60 Hz AC electromagnetic |
| 100, 120, 150, 180, 200, | fields |
| 240 Hz, centering function: | |
| −1 Hz to +2 Hz | |
| Gamma, 40 Hz to 98 Hz | In EEG, this range is considered to be |
| | important to follow when the brain |
| | processes memories. For the measuring |
| | device 100, this range is important |
| | because of its interference between |
| | human body-related frequencies and |
| | general EMF polluting frequencies such |
| | as utility pollution and wireless |
| | communication signals |

Referring next to FIG. 6, there is shown an illustration of presentation material advertising the measuring device 100, and a manner in which EMR-fingerprints are generated and shared. In FIG. 7, there is shown an exterior view of an embodiment of the measuring device 100 of FIG. 1. The measuring device 100 in FIG. 7 includes a hook for enabling the measuring device 100 to be hung in air or stood on a supporting surface. The measuring device 100 includes a lid through which a rechargeable battery of the measuring device 100 can be recharged and/or data is susceptible to being downloaded to the measuring device 100. One of the sensors of the measuring device 100 includes an Iron core for concentrating and attracting magnetic fields thereto; optionally, this Iron core is associated with the sensor included substantially within the liquid 230. Another of the sensors is implemented as an “air grounding” solenoid winding; optionally, an implementation using a metallic tube or insulated ceramic is employed.

Referring next to FIG. 8, there is shown an illustration of an interface in which analysis results of measurements taken using the measuring device 100 are presented, for example an EMR-fingerprint of a given user or a given environment. Such a EMR-fingerprint is susceptible, pursuant to the present disclosure, to being shared via a social media communication network to one or more other users, for example for making comparisons, for performing trend analysis and so forth.

The interface as shown in FIG. 8 is optionally presented on a portable wireless communication device, for example on a graphical user interface of a smartphone device. Such presentation enables swipe motions of a user's fingers on a touch-screen associated with the graphical user interface to be used to control analysis executed in respect of measurement made via use of the measuring device 100. For example, For example, by using a swiping motion at the touch screen of the graphical user interface, measurements made by the measuring device 100 are sent to a remote server for further analysis for feedback purposes for the user, client or similar. Moreover, such feedback enables an evaluation of a nature of measured EMF pollution, or expressing in words how the EMF fingerprint is influencing the user's neurological state, and reactions to material or changes in an external EMF field.

Additionally or alternatively a measuring device can be integrated as part of clothing such as glove, shoe, hat, shirt etc in order to enable monitoring of electric and/or magnetic fields round the user.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A measuring device for measuring one or more electromagnetic fields, wherein the measuring device includes:
a measuring sensor arrangement which is operable to detect the one or more electromagnetic fields and to generate one or more corresponding measurement signals; and
a data processing arrangement which is operable to process the one or more corresponding signals to generate an analysis of the one or more electromagnetic fields,
wherein the measuring device includes a liquid for at least partially influencing at least a part of the measuring sensor arrangement for simulating one or more physiological effects of the one or more electromagnetic fields.

2. The measuring device as claimed in claim 1, wherein the measuring device is operable to measure one or more components of the one or more electromagnetic fields at very low frequencies, wherein the very low frequencies are less than substantially 256 Hz.

3. The measuring device as claimed in claim 1, wherein the measuring device is operable to measure and analyze the one or more electromagnetic fields in one or more frequency ranges, namely:
(i) in a Delta frequency range of substantially 1 Hz to 4 Hz;
(ii) in a Theta frequency range of substantially 4 Hz to 7 Hz;
(iii) in frequency ranges centred on one of more of frequencies 50 Hz, 60 Hz, 100 Hz, 120 Hz, 150 Hz, 180 Hz, 200 Hz, 240 Hz, wherein the frequency range are substantially −1 Hz to +2 Hz of their respective centre frequency;
(iv) in a Gamma frequency range of substantially 40 Hz to 98 Hz.

4. The measuring device as claimed in claim 1, wherein the measuring device further includes a display arrangement for presenting in operation the analysis of the one or more electromagnetic fields.

5. The measuring device as claimed in claim 1, wherein the measuring sensor arrangement includes a plurality of sensors, of which at least one sensor is operable to sense an ambient electromagnetic field external to the measuring device, and at least one sensor which is operable to sense an electromagnetic field which penetrates into the liquid.

6. The measuring device as claimed in claim 5, wherein at least one sensor which is operable to sense an ambient electromagnetic field external to the measuring device is disposed at a periphery of the measuring device in a manner at least partially surrounding the liquid.

7. The measuring device as claimed in claim 6, wherein the at least one sensor which is operable to sense an electromagnetic field which penetrates into the liquid is disposed within the liquid, wherein the liquid comprises at least one of:
(i) a water-based solution comprising one or more salts;
(ii) a water-based suspension of biological material;
(iii) a water-based mixture of biological long-chain molecules which have one or more molecular resonances corresponding to the electromagnetic field; and
(iv) a water-based mixture containing magnetotactic bacteria.

8. The measuring device as claimed in claim 7, wherein the water-based solution comprises substantially in a range of substantially 0.1% to 2.0% salt solution.

9. The measuring device as claimed in claim 6, wherein the liquid is exchangeable by way of corresponding liquid-filled cartridge exchange.

10. The measuring device as claimed in claim 8, wherein the water-based solution comprises substantially 0.9% (+/−0.2%) Sodium Chloride (NaCl).

11. The measuring device as claimed in claim 6, wherein at least one sensor which is operable to sense an ambient electromagnetic field external to the measuring device is disposed with an air gap between it and a region comprising the liquid, wherein the air gap is in a range of 2 mm to 10 mm, more optionally substantially 5 mm.

12. The measuring device as claimed in claim 1, wherein the data processing arrangement is operable to present the analysis in a form of frequency spectrum results.

13. The measuring device as claimed in claim 1, wherein the data processing arrangement is operable to compute, for the analysis, a weighed average index (I) of a plurality of average levels (A), a standard deviation of the average of a plurality of average levels (B), and a correlation of the average levels (C).

14. The measuring device as claimed in claim 13, wherein the data processing arrangement is operable to compute the average levels (A) based upon the average of measured frequency band magnitude values.

15. The measuring device as claimed in claim 13, wherein the data processing arrangement is operable to compute a standard deviation of the average of the plurality of average levels (B) based upon an average of the standard deviation according to a weighing factor (wf).

16. The measuring device as claimed in claim 13, wherein the data processing arrangement is operable to compute a correlation of the average levels (C) based upon a relative change in average level frequency band magnitudes compared to change in measured specific frequency band magnitudes.

17. The measuring device as claimed in claim 1, wherein the data processing arrangement is operable to compute the analysis by employing computing resources based in a computing hub which is spatially remote from the measuring sensor arrangement.

18. A method of using a measuring device for measuring one or more electromagnetic fields, wherein the method includes:
(a) using a measuring sensor arrangement to detect the one or more electromagnetic fields and to generate one or more corresponding measurement signals; and
(b) using a data processing arrangement to process the one or more corresponding signals to generate an analysis of the one or more electromagnetic fields,
wherein the method includes, for the measuring device, using a liquid for at least partially influencing at least a part of the measuring sensor arrangement for simulating one or more physiological effects of the one or more electromagnetic fields.

19. The method as claimed in claim 18, wherein the measuring device is operable to measure one or more components of the one or more electromagnetic fields at very low frequencies, wherein the very low frequencies are less than substantially 60 Hz.

20. The method as claimed in claim 18, wherein the measuring device is operable to measure and analyze the one or more electromagnetic fields in one or more frequency ranges, namely:
(i) in a Delta frequency range of substantially 1 Hz to 4 Hz;
(ii) in a Theta frequency range of substantially 4 Hz to 7 Hz;
(iii) in frequency ranges centred on one of more of frequencies 50 Hz, 60 Hz, 100 Hz, 120 Hz, 150 Hz, 180 Hz, 200 Hz, 240 Hz, wherein the frequency range are substantially −1 Hz to +2 Hz of their respective centre frequency;
(iv) in a Gamma frequency range of substantially 40 Hz to 98 Hz.

21. The method as claimed in claim 19, wherein the method includes using a display arrangement of the measuring device for presenting in operation the analysis of the one or more electromagnetic fields.

22. The method as claimed in claim 19, wherein the measuring sensor arrangement includes a plurality of sensors, of which at least one sensor is operable to sense an ambient electromagnetic field external to the measuring device, and at least one sensor which is operable to sense an electromagnetic field which penetrates into the liquid.

23. The method as claimed in claim 22, wherein the at least one sensorwhich is operable to sense an ambient electromagnetic field external to the measuring device is disposed at a periphery of the measuring device in a manner at least partially surrounding the liquid.

24. The method as claimed in claim 23, wherein the at least one sensor which is operable to sense an electromagnetic field which penetrates into the liquid is disposed within the liquid, wherein method includes arranging for the liquid comprises at least one of:
(i) a water-based solution comprising one or more salts;
(ii) a water-based suspension of biological material;
(iii) a water-based mixture of biological long-chain molecules which have one or more molecular resonances corresponding to the electromagnetic field; and
(iv) a water-based mixture containing magnetotactic bacteria.

25. The method as claimed in claim 23, wherein the water-based solution comprises substantially in a range of substantially 0.5% to 2.0% salt solution.

26. The method as claimed in claim 25, wherein the water-based solution comprises substantially 0.9% Sodium Chloride (NaCl).

27. The method as claimed in claim 23, wherein at least one sensor (102) which is operable to sense an ambient electromagnetic field external to the measuring device (100, 200) is disposed with an air gap between it and a region comprising the liquid, wherein the air gap is in a range of 2 mm to 10 mm, more optionally substantially 5 mm.

28. The method as claimed in claim 19, wherein the data processing arrangement is operable to present the analysis in a form of frequency spectrum results.

29. The method as claimed in claim 19, wherein the data processing arrangement is operable to compute, for the analysis, a weighed average index (I) of a plurality of average levels (A), a standard deviation of the average of a plurality of average levels (B), and a correlation of the average levels (C).

30. The method as claimed in claim 29, wherein the data processing arrangement is operable to compute the average levels (A) based upon the average of measured frequency band magnitude values.

31. The method as claimed in claim 29, wherein the data processing arrangement is operable to compute a standard deviation of the average of the plurality of average levels (B) based upon an average of the standard deviation according to a weighing factor (wf).

32. The method as claimed in claim 29, wherein the data processing arrangement is operable to compute a correlation of the average levels (C) based upon a relative change in average level frequency band magnitudes compared to change in measured specific frequency band magnitudes.

33. The method as claimed in claim 19, wherein the data processing arrangement is operable to compute the analysis by employing computing resources based in a computing hub which is spatially remote from the measuring sensor arrangement.

34. A software product recorded on non-transient machine-readable data storage media, wherein the software product is executable upon computing hardware of the data processing arrangement of the measuring device as claimed in claim 1 for implementing a method as claimed in claim 19.
